(19) United States
(12) Patent Application Publication
(10) Pub. No.: US 2009/0320537 A1
(43) Pub. Date: Dec. 31, 2009

(54) TAMPER EVIDENT SECURITY LOCK

(76) Inventor: Richard Keith Alexander, Kenosha, WI (US)

Correspondence Address: BRINKS HOFER GILSON & LIONE, P.O. BOX 10395, CHICAGO, IL, 60610, US

(21) Appl. No.: 12/491,748

(22) Filed: Jun. 25, 2009

Related U.S. Application Data
(60) Provisional application No. 61/076,539, filed on Jun. 27, 2008.

(51) Int. Cl. E05B 39/00; E05B 47/00; G08B 29/00

(52) U.S. Cl. 70/277; 70/439; 340/5.2

(57) ABSTRACT

A tamper evident security lock includes a tamper evident security system to indicate whether the tamper evident security lock has been improperly accessed. The tamper evident security system includes a tamper evident security module that invokes different sets of logic to generate a sequence of characters displayable through a viewing window incorporated into the tamper evident security lock. The tamper evident security system may also include a processor activatable by an actuator in communication with a shackle or other component of the tamper evident security lock. The shackle works in conjunction with the actuator to activate the processor, and when the processor is activated, the tamper evident security system generates the sequence of characters. The sequence of characters may change each time the processor is activated so that a person authorized to unlock the tamper evident security lock can identify whether the tamper evident security lock was improperly accessed.

### RELATED APPLICATIONS

This application claims the benefit of priority under 35 U.S.C. §119(e) to U.S. Pat. App. No. 61/076,539, filed Jun. 27, 2008, which is incorporated by reference herein in its entirety.

### BACKGROUND

1. Technical Field

This application relates to a tamper evident security lock, and in particular, to a tamper evident security lock that displays a sequence of characters in response to the change in state of a movable activation member.

2. Related Art

Traditional padlocks are generally used to protect or secure an item from unauthorized access, such as doors, gates, lockers, shipping containers, or other items. In a locked position, a traditional padlock generally prevents an unauthorized person from gaining access to the item protected by the padlock. The padlock prevents access to the protected item because the padlock is generally constructed of heavy-duty materials, such as steel or iron. However, a traditional padlock may be equipped with an unlock mechanism that unlocks the padlock to allow authorized access to the protected item. The unlock mechanism may take the form of a properly teethed key or combination code. A person or entity that has authorization to unlock the padlock usually possesses the properly teethed key or combination code. Accordingly, the combination of the heavy-duty materials and the unlock mechanism possessed by the padlock generally prevent unauthorized persons or entities from accessing the item protected by the padlock.

In one application, a traditional padlock may be used to secure an item, such as a shipping container, truck, or other item, during shipping. For example, a shipper that sends a shipping container to a recipient may use a padlock to secure the shipping container while the shipping container is in transit to the recipient. The shipper may use the padlock under the belief that the padlock will maintain the integrity of the shipping container. Similarly, the recipient may check the padlock upon receipt of the shipping container to determine whether the integrity of the shipping container was violated.

However, there are circumstances in which an unauthorized person may gain undetected access to the protected item or violate the integrity of an item protected by the padlock. For example, the unauthorized person may make a copy of the properly teethed key or may learn of the padlock's combination code. In other circumstances, the unauthorized person may bypass the padlock's unlock mechanism, such as by lock-picking or other means. In many instances, an unauthorized person can simply re-lock a traditional padlock to mask the unauthorized access of the protected item. As applied to the application described above, a shipper may now have the mistaken belief that the shipping container is secured by the traditional padlock and the recipient may be left with no way to determine whether the integrity of the shipping container was violated.

Hence, a traditional padlock does not provide the security of preventing access to a protected item by an unauthorized person.

### SUMMARY

A tamper evident security padlock includes a tamper evident security system situated inside the outer housing of a padlock. The tamper evident security system is configured to output a sequence of characters on an output device in communication with the outer housing of the pad lock. The tamper evident security system may generate the sequence of characters randomly, pseudo-randomly, or in a predetermined fashion. The sequence of characters may include any type of characters, including letters and numbers, but also colors, sounds, or any other type of character.

The tamper evident security system includes several components. In one implementation, the tamper evident security system includes a memory storage device and a processor. The memory storage device may store executable instructions that define a tamper evident security module. The processor may be operable to execute the executable instructions.

The tamper evident security module may include logic operable to generate the displayable sequence of characters. In one implementation, the tamper evident security module includes pseudo-random character generator logic operable to generate a pseudo-random sequence of characters. In another implementation, the tamper evident security module includes predetermined character generator logic operable to generate a predetermined sequence of characters. The predetermined sequence of characters may be selected from a predetermined character sequence set.

In another implementation, the tamper evident security system includes an environment characteristic sensor operable to detect an environment characteristic of the environment surrounding the padlock. Examples of environment characteristics include light, noise, temperature, and other environment characteristics. The environment characteristic sensor may also include an analog-to-digital converter that converts an analog signal representing the environment characteristic detected by the environment characteristic sensor to a digital signal. The tamper evident security module may include sensor characteristic conversion logic operable to convert the digital signal to a digital value. Random character generator logic implemented by the tamper evident security module may communicate with the sensor characteristic conversion logic to generate a random sequence of characters based on the digital value. In another implementation, the random character generator logic communicates with the environment characteristic sensor and the sensor characteristic conversion logic to generate the random sequence of characters.

The tamper evident security system may be activated by an actuator in communication with a movable activation member of the padlock. An example of a movable activation member is a shackle in communication with the outer housing of the padlock. Other examples of movable activation members include locking balls, a lock cylinder, a key, and or other types of movable activation members. The actuator may activate the tamper evident security system when the movable activation member is moved from a locked position to an unlocked position or moved from an unlocked position to a locked position.

The outer housing of the padlock may include a cutout portion with an output device in communication with the cutout portion. For example, the outer housing may include a liquid crystal display (“LCD”), a display of light emitting diodes, or other type of display, in communication with the cutout portion. When the actuator activates the tamper evident security system, the generated sequence of characters may be displayed on the display that is in communication with the outer housing. In general, the output device may be any type of output device including a speaker, a microphone, a recordable medium, or any other type of output device now known or later developed.

Other systems, methods, features and advantages will be, or will become, apparent to one with skill in the art upon examination of the following figures and detailed description. All such additional systems, methods, features and advantages are included within this description, are within the scope of the invention, and are protected by the following claims.

### BRIEF DESCRIPTION OF THE DRAWINGS

The system may be better understood with reference to the following drawings and description. The elements in the figures are not necessarily to scale, emphasis instead being placed upon illustrating the principles of the system. In the figures, like-referenced numerals designate corresponding parts throughout the different views.

FIG. 1 shows one example of a tamper evident security lock.

FIG. 2 shows another example of a tamper evident security lock.

FIG. 3 shows an exploded view of the tamper evident security lock from FIG. 2.

FIG. 4 shows an internal view the tamper evident security lock from FIG. 1.

FIG. 5 shows an exploded view of one example of a lock cylinder for the tamper evident security lock.

FIG. 6 shows one example of an unlock mechanism activating an authorization sensor.

FIG. 7 shows one example of a tamper evident security system.

FIG. 8 shows another example of a tamper evident security system.

FIG. 9 shows a further example of a tamper evident security system.

FIG. 10 shows one example of logic flow in implementing a tamper evident security lock.

FIG. 11 shows continuing logic flow from FIG. 10.

FIG. 12 shows one example of logic flow in applying a tamper evident security lock.

### DETAILED DESCRIPTION OF THE PREFERRED EMBODIMENTS

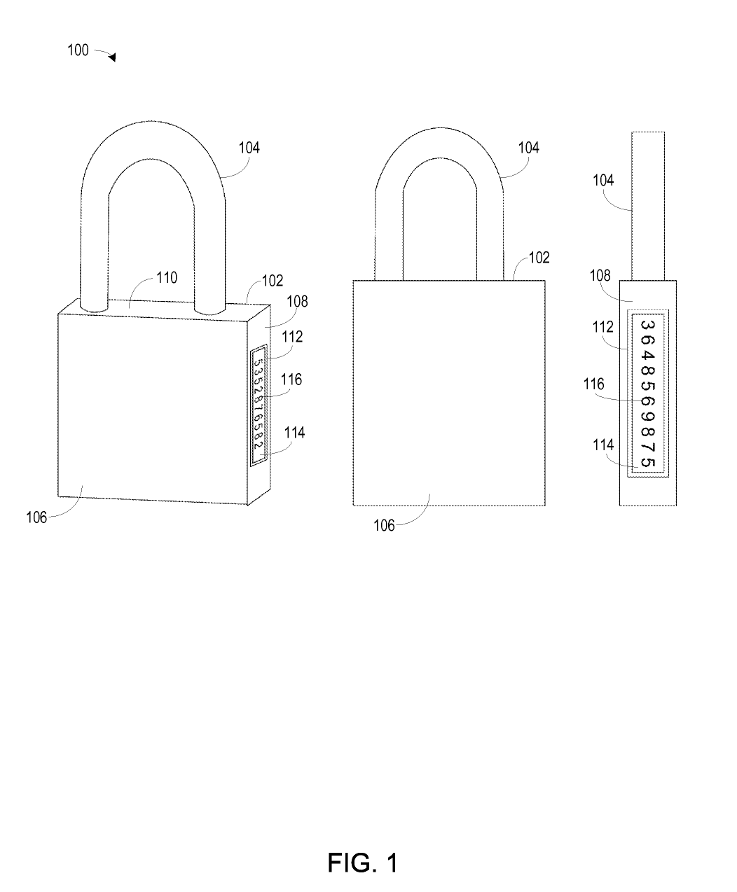

FIG. 1 shows one example of a tamper evident security lock 100. The tamper evident security lock 100 includes an outer housing 102 in communication with a shackle 104. The outer housing 102 may have several different faces, including a front face (not shown), a back face 106, a right face 108, a left face (not shown), a bottom face (not shown), and a top face 110. In one implementation, the shackle 104 is in communication with the top face 110 of the outer housing 102. The shackle 104 may also be slidably moveable through the top face 110 or any of the other faces 106-110.

The outer housing 102 may also include a vertical cutout portion 112. The vertical cutout portion 112 may be a hole or other portion of the outer housing 102 that has been removed. The vertical cutout portion 112 may be located in any one of the faces 106-110 of the outer housing 102. In one implementation, the vertical cutout portion 112 is located in the right face 108 of the outer housing 102. In another implementation, the vertical cutout portion 112 is located in the shackle 104. However, the vertical cutout portion 112 may be located in any part of the tamper evident security lock 100.

An output device 114 is mounted within the vertical cutout portion 112. The output device 114 may be mounted using an adhesive, such as tape, glue, or other adhesive, or a securing member, such as a screw, nut, nail, bolt, or other securing member. The output device 114 may be a display, such as an LCD, an LED display, or any other type of display. In one implementation, the output device 114 is an AND671GST LCD available from Purdy Electronics Corp. located in Sunnyvale, Calif. However, the output device 114 may be any other output device, such as a speaker, recordable medium, printer, or any other device now known or later developed that receives and/or communicates output.

In one implementation, the output device 114 is operable to output a generated sequence of characters 116. The sequence of characters 116 may be any type, length, or combinations of characters. For example, the sequence of characters 116 may include letters, numbers, symbols, or any other alphanumeric character. In one implementation, the sequence of characters 116 has ten characters. However, the sequence of characters 116 may include any number of characters.

In one implementation, the tamper evident security lock 100 is a solid steel body padlock model number 532DLHPF available from Master Lock Company LLC located in Oak Creek, Wis. However, the tamper evident security lock 100 may be any type of lock. For example, the tamper evident security lock 100 may be a combination lock, a padlock, a cam lock, a door lock, a drawer lock, a pin tumbler lock, or any other lock now known or later developed.

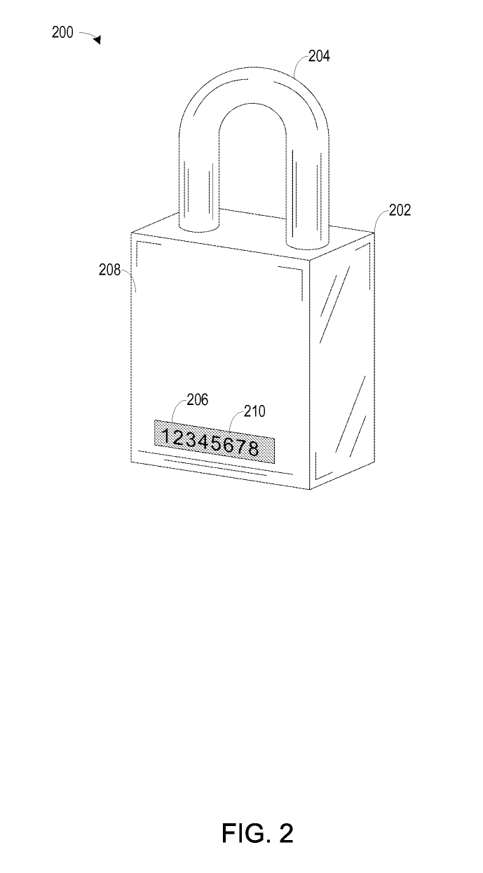

FIG. 2 shows another example of a tamper evident security lock 200. Where the tamper evident security lock 200 of FIG. 2 has similar components as the tamper evident security lock 100 of FIG. 1, a discussion of those components has been omitted.

Like the tamper evident security lock 100 of FIG. 1, the tamper evident security lock 200 has an outer housing 202 in communication with a slidably movable shackle 204. In contrast to the tamper evident security lock 100 of FIG. 1, the tamper evident security lock 200 of FIG. 2 includes a horizontal cutout portion 206 located on the front face 208 of the outer housing 202. However, the horizontal cutout portion 206 may be located on any of the faces of the outer housing 202 or on any part of the tamper evident security lock 200. An output device 210 operable to display a sequence of characters is mounted within the horizontal cutout portion 206. The output device 210 may be the same type of output device as the output device 114 of FIG. 1, or the output device 210 may be a different type of output device.

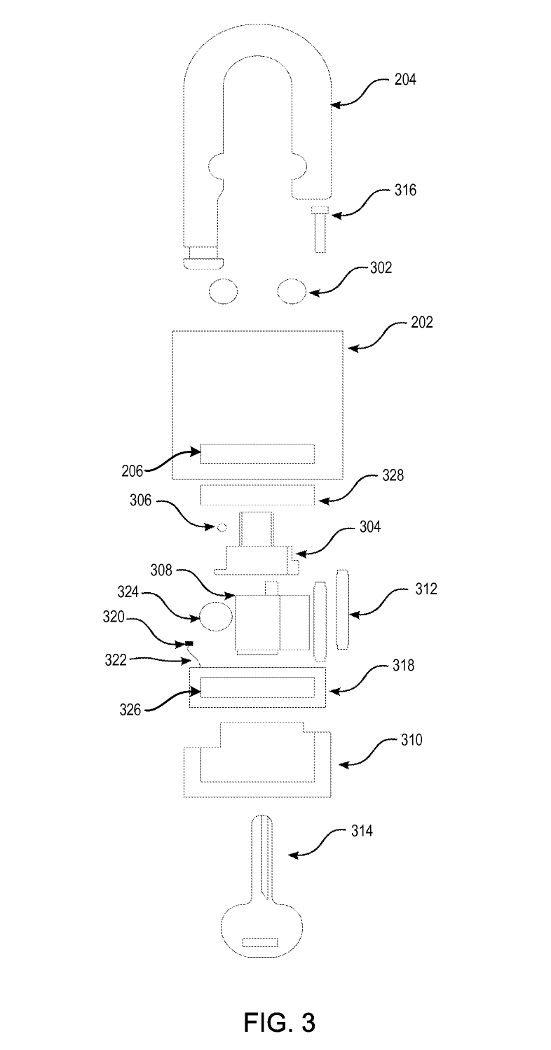

FIG. 3 shows an exploded view of the tamper evident security lock 200 from FIG. 2. The tamper evident security lock 200 may include traditional locking components and mechanisms. For example, the tamper evident security lock 200 may include a set of locking balls 302 situated within the outer housing 202. The locking balls 302 are laterally movable within the outer housing 202. When the shackle 204 slides from an unlocked position to a locked position, the locking balls 302 extend into the radial recesses of the shackle 204. Similarly, when the shackle 204 slides from the locked position to the unlocked position, the locking balls 302 are dislodged from the radial recesses of the shackle 204. To contain the movement of the locking balls 302, the tamper evident security lock 200 includes a latching section 304.

A shackle stop 306 is disposed within the outer housing 202 of the tamper evident security lock 200. The shackle stop 306 prevents the shackle 204 from being released from the tamper evident security lock 200 while in the unlocked position. As the shackle 204 is free to slidably move between the unlocked position and the locked position, the shackle stop 306 prevents the shackle 204 from being completely removed from the outer housing 202.

A lock cylinder 308 operates to contain any of a variety of locking mechanisms, including a pin tumbler lock, a wafer tumbler lock and/or a disc tumbler lock. The cylinder limits the access to the latching mechanism within the lock. The lock cylinder 308 communicates with the latching section 304 to secure the shackle 204 in the locked position. A key 314 is slidably insertable into the lock cylinder 308 and is an unlock mechanism for the lock cylinder 308. When inserted into the lock cylinder 308, the key is rotatable about a vertical axis to change the lock cylinder 308 from the unlocked state to the locked state, or from the locked state to the unlocked state. In other implementations, the tamper evident security lock 200 uses a combination code as an unlock mechanism or other unlock mechanism.

An inner housing 310 contains the set of components residing within the outer housing 202. The inner housing 310 couples with the outer housing 202 and secures the components from shifting or movement. The inner housing 310 may contain the lock cylinder 308, the latching section 304, the shackle stop 306, and other components. The inner housing 310 may be tightly sealed with the outer housing 202. The seal between the inner housing 310 and the outer housing 202 may be an air-tight seal, a water-tight seal, or any other type of seal. The seal may be formed by sealing mechanisms, such as welding, screws, nuts, bolts, pins, nails, adhesives, glues, or other sealing mechanisms.

The seal between the outer housing 202 and the inner housing 310 may protect the components within the outer housing 202 from exposure or damage from external elements or forces. Examples of external elements include rain, snow, wind, sand, water, or other external elements. Examples of force elements include dropping the tamper evident security lock 200, striking the tamper evident security lock 200, heating the tamper evident security lock 200, or other force elements. There may also be a seal that seals the outer housing 202, a seal that seals the inner housing 310, or combination of seals.

A set of alignment pins 312 are vertically disposed within the inner housing 310. The alignment pins 312 couple the inner housing 310 with the outer housing 202. The alignment pins 312 also assist in maintaining proper alignment of the inner housing 310 during assembly of the inner housing 310.

An assembly screw 316 secures the tamper evident security lock 200. The assembly screw 316 may be vertically disposed within the outer housing 202 and tightened to prevent the outer housing 202 from releasing the inner housing 310.

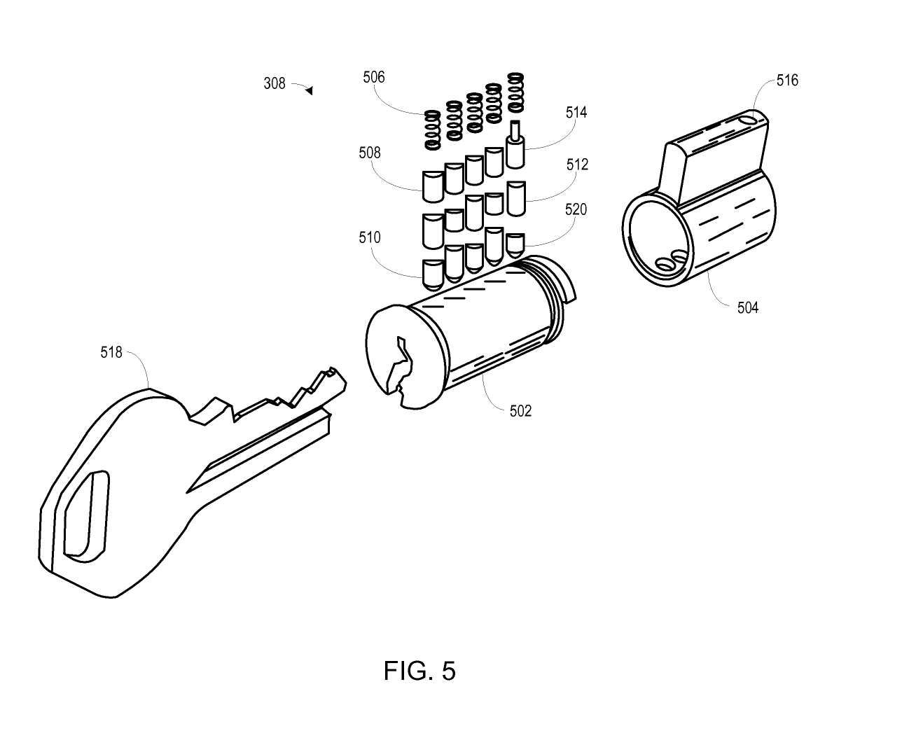

In addition to traditional locking components and mechanisms, the tamper evident security lock 200 also includes a tamper evident security system 318. Details of the tamper evident security system 318 are explained with reference to FIGS. 5-7. The tamper evident security system 318 is in communication with an actuator 320 via a connection 322. The connection 322 may be made using a wire or other material. The connection 322 may also be a wireless connection. A power source 324, such as a battery or other power source, provides power to the tamper evident security system 318.

The tamper evident security system 318 operates in an activation state and in a non-activation state. In the activation state, the tamper evident security system 318 generates a sequence of characters. The generated sequence of characters is displayable on an output device 326 and viewable through a transparent window 328. The transparent window 328 may be mounted on the inside surface of the outer housing 202 and situated between the output device 326 and the cutout portion 206 of the outer housing 202.

The actuator 320 is movable between a first state that does not activate the tamper evident security system 318 and a second state that activates the tamper evident security system 318. The actuator 320 may be mechanically movable, electrically movable, or movable in some other fashion. The state of the actuator 320 may correspond to the position of the shackle 204, the position of the lock cylinder 308, or of the position of any other component in the tamper evident security lock 200.

In one implementation, the actuator is moved from the first state that does not activate the tamper evident security system 318 to the second state that activates the tamper evident security 318 when the shackle 204 makes contact with the actuator 320. For example, when the shackle 204 is changed from an unlocked position to a locked position, the shackle 204 may contact the actuator 320. Contacting the actuator 320 may be direct or indirect contact. By making contact with the actuator 320, the shackle 204 may cause the actuator 320 to activate the tamper evident security system 318, such as by transmitting a signal to the tamper evident security system 318 or by completing an electrical circuit that activates the tamper evident security system 318. In another implementation, the shackle 204 may move the actuator 320 from the first state to the second state when the shackle 204 is moved from the locked position to the unlocked position. When the shackle 204 is moved to the locked position, the tamper evident security system 318 may cause the continuous display of the sequence of characters on the output device 326. The sequence of characters displayed on the output device 326 may be continuously displayed until the shackle 204 is moved to the unlocked position, until the tamper evident security system 318 is deactivated, or until some other event occurs.

After activating the tamper evident security system 318, the actuator 320 may deactivate the tamper evident security system 318 when the shackle 204 is moved from the locked position to the unlocked position. Alternatively, the actuator 320 may deactivate the tamper evident security system 318 when the shackle 203 is moved from the unlocked position to the locked position. In either example, after the actuator 320 activates the tamper evident security system 318, the shackle 204 may contact the actuator 320 so as to cause the actuator 320 to deactivate the tamper evident security system 318. Deactivating the tamper evident security system 318 may also cause the output device to discontinue displaying the sequence of characters. After deactivation, the actuator 320 may reactivate the tamper evident security system 318. The actuator 320 may reactivate the tamper evident security system 318 when the shackle 204 is moved from the unlocked position to the locked position. Alternatively, the actuator 320 may reactivate the tamper evident security system 318 when the shackle 204 is moved from the locked position to the unlocked position. When reactivated, the tamper evident security system 318 may re-generate a second sequence of characters. The second sequence of characters may be displayable on the output device 326. The second sequence of characters may be different than the first sequence of characters that the tamper evident security system 318 generated when the tamper evident security system 318 was first activated. As explained below, the second sequence of characters may be different than the first sequence of characters because each sequence of characters may be randomly or pseudo-randomly generated. Alternatively, the first and second sequence of characters may be selected from a known set of sequence of characters and displayed based on the order in which the first and second sequence of characters appear in the known set.

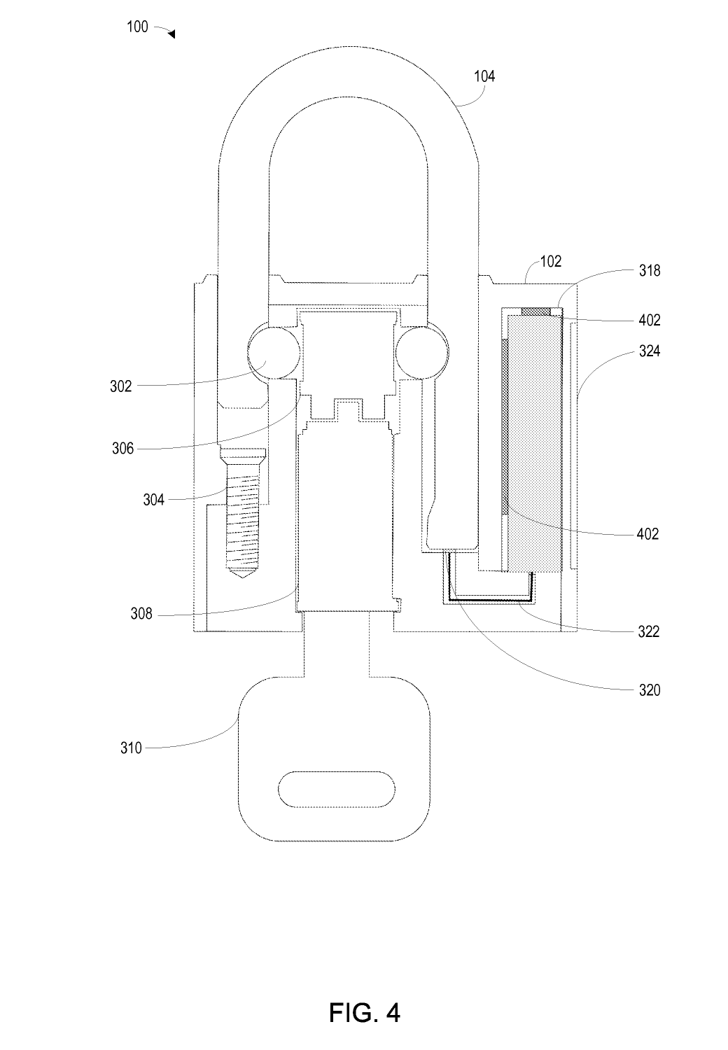

FIG. 4 is an internal view of the tamper evident security lock 100 from FIG. 1. Where the tamper evident security lock 100 of FIG. 4 has similar internal components as the tamper evident security lock 200 of FIG. 3, a discussion of those components has been omitted. As shown in FIG. 4, the tamper evident security lock 100 also includes the set of locking balls 302, the assembly screw 304, the latching section 306, the lock cylinder 308, and the unlock mechanism 310, such as the key. The tamper evident security lock 100 may also have other types of unlock mechanisms, such as a combination code or other unlock mechanism. The tamper evident security lock 100 may also have internal components not shown in FIG. 4, such as the shackle stop 306, alignment pins 312, the power source 324, or any of the other components.

The tamper evident security lock 100 may also have components for determining whether the tamper evident security lock 100 has been accessed. For example, the tamper evident security lock 100 may also include the tamper evident security system 318 in communication with the actuator 320 via the connection 322. The viewing window 324 may be vertically mounted to the outer housing 102 for viewing the sequence of characters generated by the tamper evident security system 318. In addition, the tamper evident security lock 100 may also include stabilizing pads 402 mounted to the tamper evident security system 318 and secured to the inner portion of the outer housing 102. The stabilizing pads 402 may be mounted to the tamper evident security system 318 using an adhesive, such as tape, or other securing mechanism, such as glue, a screw, a bolt, or a nail. In alternative implementations, the stabilizing pads 402 may be secured to the inner housing 310 (not shown) or other part of the tamper evident security lock 100.

FIG. 5 shows one example of a lock cylinder 308 for the tamper evident security lock. The lock cylinder 308 includes a lock cylinder plug 502 slidably removable from a lock cylinder hull 504. The lock cylinder plug 502 includes a first set of lock cylinder springs 506 in communication with a first set of lock cylinder pins 508 and a second set of lock cylinder pins 510. A first set of lock cylinder master wafers 512 are disposed between the first set of lock cylinder pins 508 and the second set of lock cylinder pins 510. The first set of lock cylinder springs 506, the first set of lock cylinder pins 508, and the second set of lock cylinder pins 510 are vertically disposed in the lock cylinder hull 502.

The first set of lock cylinder pins 508 include a primary lock cylinder actuation pin 514. The primary lock cylinder actuation pin 514 is slidably insertable into an lock cylinder actuation hole 516 disposed in the lock cylinder hull 504. When an authorized unlock mechanism, such as a properly teethed key 518, is inserted into the lock cylinder plug 502, the authorized unlock mechanism contacts a secondary lock cylinder actuation pin 520.

In response to contact by the authorized unlock mechanism, the secondary lock cylinder actuation pin 520 vertically moves and contacts the primary lock cylinder actuation pin 514. When the primary lock cylinder actuation pin 514 is contacted by the secondary lock cylinder actuation pin 520, the primary lock cylinder actuation pin 514 vertically moves and enters the actuation hole 516.

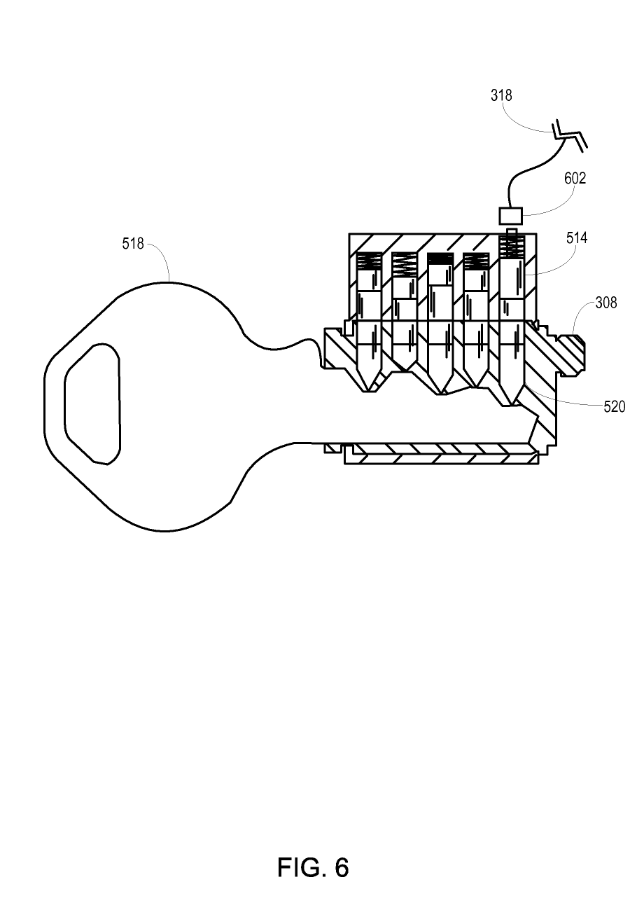

As explained below with reference to FIG. 6, when the primary lock cylinder actuation pin 514 enters the lock cylinder actuation hole 516, the primary lock cylinder actuation pin 514 contacts an authorization sensor indicating that an authorized unlock mechanism is present in the tamper evident security lock.

The authorized unlock mechanism is designed to contact the secondary lock cylinder actuation pin 520 so as to cause a predetermined amount of movement in the primary lock cylinder actuation pin 514. When an unauthorized unlock mechanism, such as an improperly teethed key, is present in the lock cylinder plug 502, the unauthorized unlock mechanism does not contact the secondary lock cylinder actuation pin 520. Alternatively, the unauthorized unlock mechanism may cause an amount of movement different than the predetermined amount of movement in the primary lock cylinder actuation pin 514. Alternative arrangements of the lock cylinder 308 shown in FIG. 6 are also possible.

In one implementation, the authorized unlock mechanism includes combining a standard master key having a three-spacer combination with an additional spacer, such as a security spacer, to activate the authorization sensor. In alternative implementations, the unauthorized unlock mechanism includes a combination code, lock cylinder, a key, or any other unlock mechanism now known or later developed.

FIG. 6 shows one example of the authorized unlock mechanism 518 contacting the secondary lock cylinder actuation pin 520. In turn, the secondary lock cylinder actuation pin 520 causes a predetermined amount of vertical movement in the primary lock cylinder actuation pin 514. When the primary lock cylinder actuation pin 514 vertically moves by the predetermined amount of vertical movement, the primary lock cylinder actuation pin 514 contacts an authorization sensor 602. The authorization 602 is in communication with the tamper evident security system 318. When contacted by the primary lock cylinder actuation pin 514, the authorization sensor 602 communicates an authorized unlock signal to the tamper evident security system 318 to indicate that an authorized unlock mechanism is present in the tamper evident security lock.

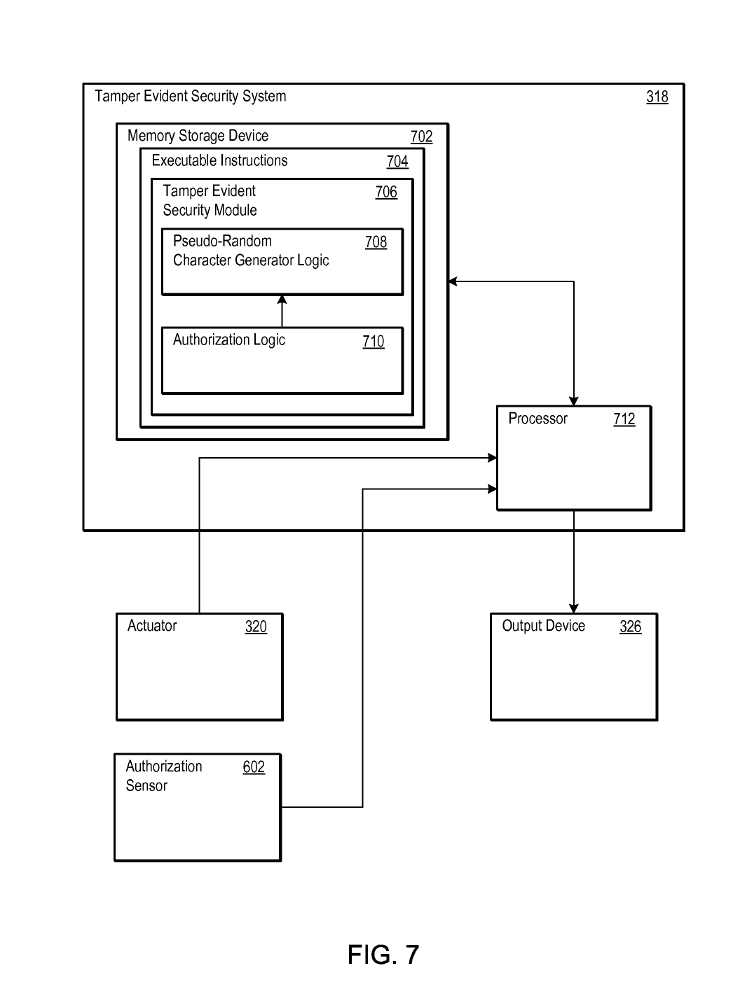

FIG. 7 shows one example of a tamper evident security system 318. In one implementation, the tamper evident security system 318 includes a memory storage device 702 in communication with a processor 712. The memory storage device 702 includes a set of executable instructions 704 that are executable by the processor 712. The processor 712 is also in communication with the actuator 320, the output device 326, and the authorization sensor 602. The tamper evident security system 318 may also include alternative components than those shown in FIG. 7.

The executable instructions 704 define a tamper evident security module 706. In one implementation, the tamper evident security module 706 includes pseudo-random character generator logic 708 and authorization logic 710. The pseudo-random character generator logic 708 may generate a pseudo-random sequence of characters. In one implementation, the pseudo-random generator logic 708 generates a single character pseudo-randomly. In this first implementation, tamper evident security module 706 invokes the pseudo-random character generator logic 708 a predetermined number of times to generate the pseudo-random sequence of characters. For example, where the output device 326 is configured to a display a sequence of ten characters, the tamper evident security module 706 may invoke the pseudo-random character generator logic 708 ten times.

In a second implementation, the pseudo-random character generator logic 708 generates a sequence of characters pseudo-randomly. For example, the pseudo-random character generator logic 708 may be configured to generate a sequence of characters of a predetermined length, such as a ten-digit number, ten letters of the alphabet, or a combination of numbers, letters and symbols. In this second implementation, the tamper evident security module 706 invokes the pseudo-random character generator logic 708 once to generate the pseudo-random sequence of characters.

The authorization logic 710 is operable to generate an authorized unlocked character sequence that indicates that the tamper evident security lock 100/200 was unlocked with an authorized unlock mechanism. The authorization logic 710 may receive an authorized unlock signal from the authorization sensor 602 via the processor 712. The authorized unlocked character sequence may be a predetermined character sequence and stored by the memory storage device 702. The authorized unlocked character sequence may be any sequence of characters including letters, numbers, symbols, or any combination thereof. The authorized unlocked character sequence may include any number of characters including one character, one hundred characters, or any other number of characters. The authorized unlocked character sequence may be output to the output device 326.

The authorization logic 710 may communicate with the pseudo-random character generator logic 708 to override or prevent the output of the pseudo-random sequence of characters to the output device 326. For example, when the tamper evident security lock 100/200 is unlocked with an authorized unlock mechanism, the authorization logic 710 may communicate to the pseudo-random character generator logic 708 that the tamper evident security lock 100/200 was unlocked with the authorized unlock mechanism. In this implementation, the authorization logic 710 may transmit the authorized unlocked character sequence to the output device 326 and the pseudo-random character generator logic 708 may not output the pseudo-random sequence of characters to the output device 326. However, in alternative implementations, the authorization logic 710 may transmit the authorized unlocked character sequence to the output device 326 and the pseudo-random character generator logic 708 may output the pseudo-random sequence of characters to the output device 326. The output device 326 may output the pseudo-random character sequence, the authorized unlock character sequence, or both.

The processor 712 may execute the executable instructions 704 based on an execution signal or execution input received from the actuator 320. For example, the actuator 320 may be configured to send the execution signal or complete a circuit that instructs the processor 712 to execute the executable instructions 704. In one implementation, when the shackle 104 is moved from the unlocked position to the locked position, the shackle 104 contacts the actuator 320, and the actuator 320 sends the execution signal to the processor 712 to execute the executable instructions 704. In an alternative implementation, when the shackle 104 is moved from the locked position to the unlocked position, the shackle 104 breaks contact with the actuator 320, and the actuator 320 sends an execution signal to the processor 712 to execute the executable instructions 704. In either implementation, the actuator 302 is in communication with the processor 712 and movable between a first state that does not activate the processor 712 to a second state that activates the processor 712 to execute the executable instructions 704.

When the processor executes the executable instructions 704, the tamper evident security module 706 may invoke the pseudo-random character generator logic 708 to generate a pseudo-random sequence of characters. The memory storage device 702 may then store the pseudo-random sequence of characters.

The tamper evident security module 706 may be configured to determine whether a currently generated pseudo-random sequence of characters is the same or equal to a previously generated pseudo-random sequence of characters. For example, the tamper evident security module 706 may implement error-checking logic to determine whether the currently generated pseudo-random sequence of characters is the same or equal to a previously generated pseudo-random sequence of characters. Where the tamper evident security module 706 determines that a currently generated pseudo-random sequence of characters is the same or equal to a previously generated pseudo-random sequence of characters, the tamper evident security module 706 may re-invoke the pseudo-random character generator logic 708 to re-generate another pseudo-random sequence of characters. The tamper evident security module 706 may continue re-invoking the pseudo-random character generator logic 708 until the currently generated pseudo-random sequence of characters is different from the previously generated pseudo-random sequence of characters. The tamper evident security module 706 may also implement alternative error checking logic to prevent a pseudo-random sequence of characters from being output or stored after one or more successive activations of the processor 712.

The processor 712 may also be operable to output a generated pseudo-random sequence of characters from the memory storage device 702 to the output device 326. For example, the processor 712 may output a generated pseudo-random sequence of characters from the memory storage device 702 to the output device 326 based on an output signal received from the actuator 320. In one implementation, the actuator 320 is operable to send an output signal to the processor 712 when the shackle 104 moves from the unlocked position to the locked position. In another implementation, the actuator 320 is operable to send an output signal to the processor 712 when the shackle 104 moves from the locked position to the unlocked position.

The processor 712 may also be operable to output the authorized unlock character sequence to the output device 326. In one implementation, the authorization sensor 602 transmits an authorized unlock signal to the processor 712 that indicates that an authorized unlock mechanism unlocked the tamper evident security lock 100/200. The authorization sensor 602 may transmit the authorized unlock signal to the processor 712 in response to the unlocking by an authorized unlock mechanism that unlocks the tamper evident security lock 100/200. The authorized unlock signal may signal to the processor 712 to execute the executable instructions 704, and in particular, the authorization logic 710. The authorized unlock signal may also indicate to the processor 712 to execute other logic from the executable instructions 704, such as the pseudo-random character generator logic 708.

The processor 712 may be operable to continuously output the generated pseudo-random sequence of characters to the output device 326. For example, the actuator 320 may be configured to continuously transmit the output signal to the processor 712 based on the position of the shackle 104. In another example, the processor 712 may continuously output the generated pseudo-random sequence of characters to the output device 326 until the processor 712 receives a discontinue output signal from the actuator 320. The execution signal, output signal, and discontinue output signal may be the same signal, different signals, or a combination thereof.

In one implementation, the processor 712 continuously outputs the generated pseudo-random sequence of characters to the output device 326 when the shackle 104 is in the locked position. In another implementation, the processor 712 discontinues output of the generated pseudo-random sequence of characters when the shackle 104 is not in the locked position.

Although the shackle 104 may contact the actuator 320 to activate the processor 712, other components may also contact the actuator 320 to activate the processor 712. For example, the lock cylinder 308, the unlock mechanism 310, the locking balls 302, or other components may contact the actuator 320 to activate the processor 712. Activating the processor 712 may include transmitting the execution signal, the output signal, the discontinue output signal, other signals, or any other combination of signals.

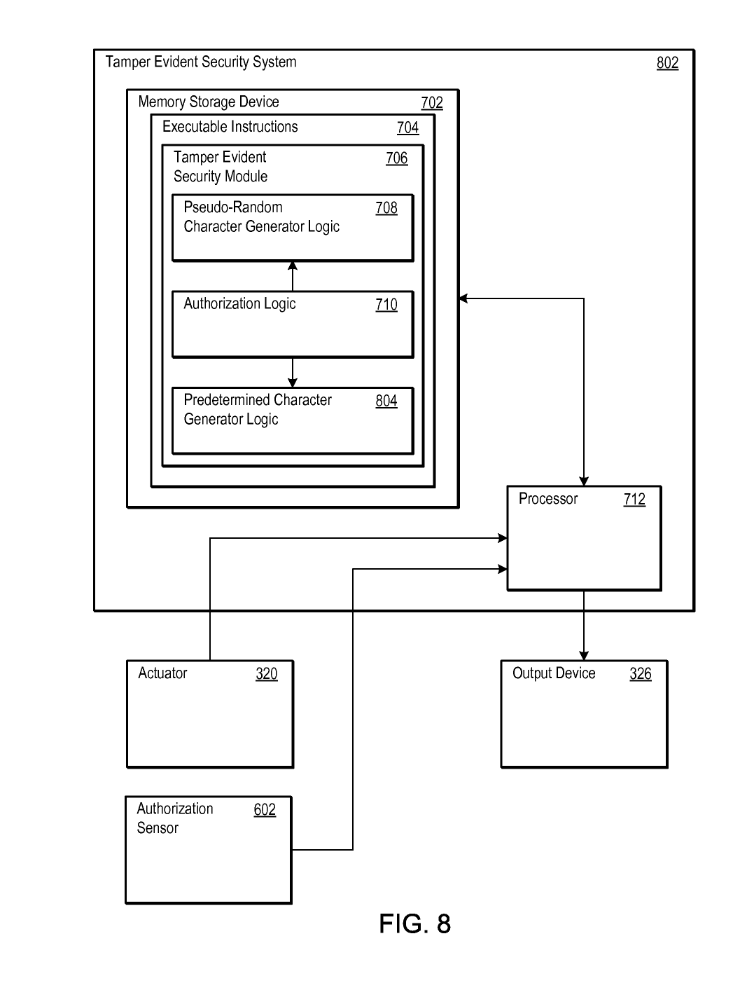

FIG. 8 shows an alternative implementation of a tamper evident security system 802. The tamper evident security system 802 also includes a tamper evident security module 706. The tamper evident security module 706 defines pseudo-random character generator logic 708, authorization logic 710, and predetermined character generator logic 804. The predetermined character generator logic 804 is operable to generate a sequence of characters according to a predetermined set of character sequences. The predetermined character generator logic 804 may also include a counter to track the current character sequence. When the tamper evident security module 706 invokes the predetermined character generator logic 804, the predetermined character generator logic 804 may increment the counter by a predetermined amount and generate a predetermined character sequence from the predetermined set of character sequences based on the incremented counter. The tamper evident security module 706 may then store the generated predetermined character sequence in the memory storage device 702 for retrieval by the processor 712.

Table 1 shows one example of a predetermined character set of character sequences where each predetermined character sequence is associated with a predetermined character set index. The predetermined character set of Table 1 includes character sequences of varying lengths with characters of varying types.

TABLE 1

| Index | Predetermined Character Sequence |
|---|---|
| 1 | AB4&5124C3 |
| 2 | QRT4321M %4 |
| 3 | 5352876582 |
| 4 | AGTRE |
| 5 | 1345678924 |

Using Table 1 as an example, when the predetermined character set index is “1,” the predetermined character generator logic 804 generates the predetermined character sequence of “AB4&5124C3.” After generating this predetermined character sequence, the predetermined character generator logic 804 may then increment the predetermined character set index by a predetermined increment amount, such as by a value of 1. Using a predetermined increment amount of “1,” the incremented value of the predetermined character index is “2.” Similarly, when the predetermined character set index has a value of “2,” the predetermined character generator logic may then generate the predetermined character sequence of “QRT432M %4.”

The predetermined character set index may be associated with a predetermined character set index lower limit value and a predetermined character set upper limit value. The predetermined character generator logic 804 may also employ logic for resetting the predetermined character set index when the predetermined character set index meets or exceeds the predetermined character set index upper limit value or the predetermined character set index lower limit value. In the example of Table 1, the predetermined character set index upper limit value is “5” and the predetermined character set index lower limit value is “1.” However, the predetermined character set index lower limit value and the predetermined character set index upper limit value may be of any value. Accordingly, in the example of Table 1, when the predetermined character set index has a value greater than or equal to the value of “5,” the predetermined character generator logic 804 may reset the predetermined character set index to a value of “1.” However, the predetermined character generator logic 804 may also decrement the predetermined character set index. Hence, in an alternative implementation, when the predetermined character set index has a value less than or equal to the value of “1,” the predetermined character generator logic 804 may reset the predetermined character set index to a value of “5.”

In an alternative implementation, the predetermined character generator logic 804 may not increment or decrement the predetermined character set index. In this alternative implementation, the pseudo-random character generator logic 708 may communicate with the predetermined character generator logic 804 to generate a predetermined character sequence from the predetermined character sequence set. For example, the pseudo-random character generator logic 708 may pseudo-randomly generate a value for the predetermined character set index, and the determined character generator logic 804 may refer to the generated value of the predetermined character set index to generate a determined character sequence.

The tamper evident security module 706 may also employ error-checking logic to prevent the predetermined character generator logic 804 from storing or outputting the same or identical predetermined character sequence. For example, the error checking logic may compare the value of a currently generated predetermined character set index with the value of a previously generated predetermined character set index, or the error checking logic may compare the currently generated predetermined character sequence with the previously generated predetermined character sequence. The tamper evident security module 706 may also implement alternative error checking logic to prevent a predetermined character sequence from being output or stored after one or more successive activations of the processor 712.

The authorization logic 710 is in communication with the pseudo-random character generator logic 708 and the predetermined character generator logic 804. The output device 326 may output the predetermined character sequence, the authorized unlock character sequence, or any other character sequence. The output device 326 may output the predetermined character sequence and the authorized unlock character sequence concurrently, separately, or not at all.

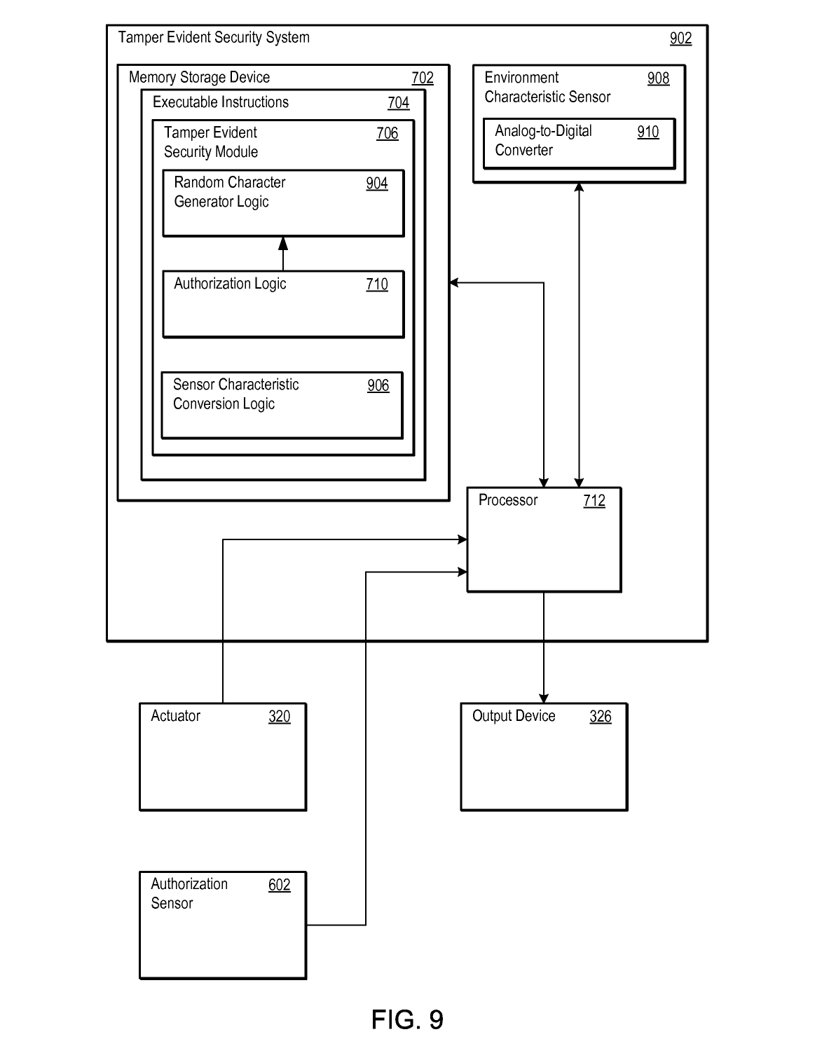

FIG. 9 shows a further example of a tamper evident security system 902. The tamper evident security system 902 is configured to generate random sequences of characters. In one implementation, the tamper evident security system 902 includes a tamper evident security module 706 that defines random character generator logic 904 and sensor characteristic conversion logic 906. The tamper evident security system 902 also includes an environment characteristic sensor 908 that includes an analog-to-digital converter 910. The environment characteristic sensor 908 is also in communication with the processor 712.

The environment characteristic sensor 908 provides the randomness property of the random sequence of characters generated by the tamper evident security module 706. The environment characteristic sensor 908 is operable to detect an environment characteristic of an environment surrounding the environment characteristic sensor 908. Examples of environment characteristics include light, sound, temperature, magnetic fields, pressure, moisture, humidity, and other environment characteristics. Accordingly, the environment characteristic sensor 908 may be a light sensor, a background noise detector, a barometer, an electrode, or any other environment characteristic sensor. The environment characteristic sensor 908 may also include one or more environment characteristic sensors.

The environment characteristic sensor 908 may sample and record one or more signals corresponding to the detected environment characteristic. In one implementation, the environment characteristic sensor 908 records analog signals corresponding to the detected environment characteristic. An analog-to-digital converter 910 is operable to convert the recorded analog signals to digital signals. The environment characteristic sensor 908 may communicate the converted digital signals to the memory storage device 702, and in particular, to the tamper evident security module 706.

When the tamper evident security module 706 receives the converted digital signals from the environment characteristic sensor 908, the tamper evident security module 706 may invoke the sensor characteristic conversion logic 906. The sensor characteristic conversion logic 906 is operable to convert the digital signals recorded by the environment characteristic sensor 908 to one or more numerical values. The digital signals from the environment characteristic sensor 908 may be converted to digital values based on amplitude, frequency, or a combination thereof.

The random character generator logic 904 is operable to generate a random sequence of characters based on the digital values converted by the sensor characteristic conversion logic 906. For example, the random character generator logic 904 may instruct the sensor characteristic conversion logic 906 to communicate a predetermined number of numerical values to the random character generator logic 904. The random character generator logic 904 may include a character mapping that maps the digital values received from the sensor characteristic conversion logic 906 to a predetermined character. The random character generator logic 904 may construct the random sequence of characters by concatenating the resulting predetermined characters from the mapping of the digital values. Alternatively, the random character generator logic 904 may construct the random sequence of characters using the digital values themselves. The randomness of the random sequence of characters may be further enhanced by altering the frequency of the samples taken by the environment characteristic sensor 908, by altering the number of environment characteristics detected by the environment characteristic sensor 908, by altering the number of mappings that exist between the numerical values converted by the sensor characteristic conversion logic 906 and the characters generated by the random character generator logic 904, or by any combination thereof.

Although shown separately in one or more figures, the tamper evident security module 706 may implement any combination of the pseudo-random character generator logic 708, the authorization logic 710, the predetermined character generator logic 804, the random character generator logic 904, the sensor characteristic conversion logic 906, or any other type of logic. In addition, when activated, the processor 712 may activate the environment characteristic sensor 908, execute the executable instructions 704, output one or more sequence of characters to the output device 326, or perform any other actions.

The authorization logic 710 is in communication with the random character generator logic 904. The output device 326 may output the random character sequence, the authorized unlock character sequence, or any other character sequence. The output device 326 may output the random character sequence and the authorized unlock character sequence concurrently, separately, or not at all.

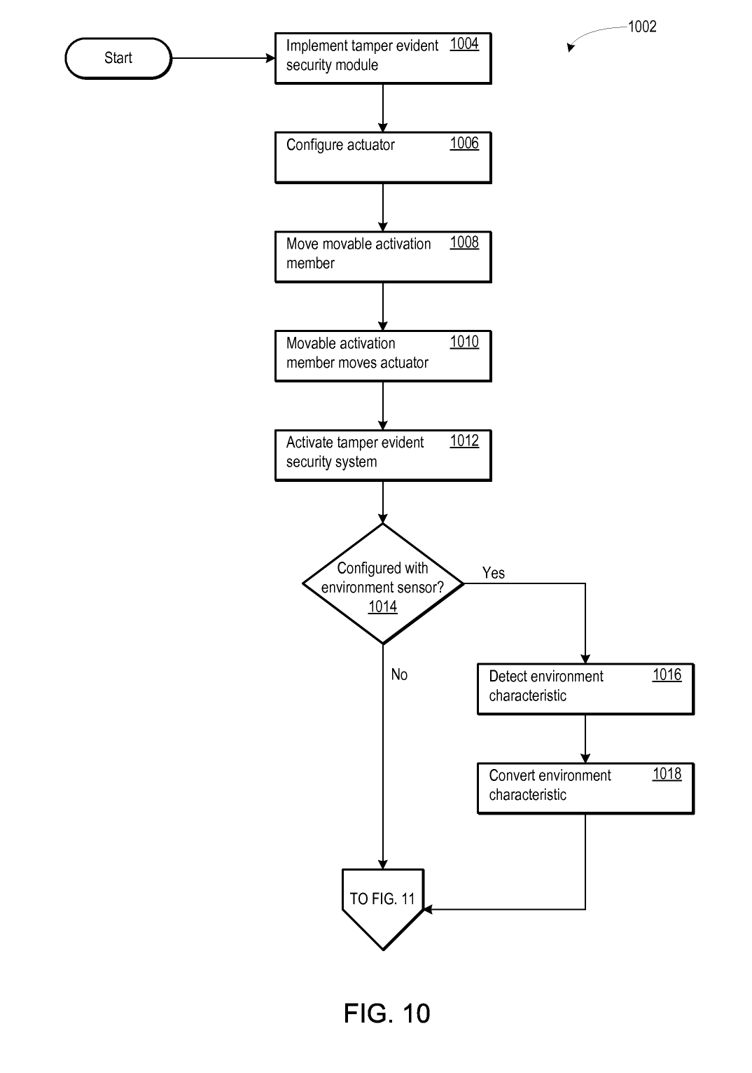

FIG. 10 shows one example of logic flow 1002 in implementing the tamper evident security lock 100/200. The logic flow 1002 initially includes implementing the tamper evident security module 706 (1004). Implementing the tamper evident security module 706 may also include implementing one or more of the logics previously described with reference to FIGS. 5-7. The logic flow 1002 also includes configuring the actuator 320 to activate the tamper evident security system 318/802/902 (1006), such as by activating the processor 712. In addition, configuring the actuator 320 may include configuring the actuator to send one or more signals to the processor 712, such as an execute signal, an output signal, a discontinue output signal, or any other type of signal or combinations of signals. Configuring the actuator 320 may also include configuring the actuator 320 to send one or more signals to the processor 712 based on the positions or states of one or more movable activation members of the tamper evident security lock 100/200. For example, the actuator 320 may be configured to activate the processor 712 when the shackle 104 reaches the locked position, the unlocked position, or any other position.

After the actuator 320 is configured (1006), the movable activation member, such as the shackle 104, is moved from a first position, such as the unlocked position, to a second position, such as the locked position (1008). When the movable activation member is moved, the movable activation member moves the actuator 320 (1010). Depending on how the actuator 320 is configured, moving the actuator 320 may activate the tamper evident security system 318/802/902 (1012).

When the tamper evident security system 318/802/902 is activated, the tamper evident security system 318/802/902 may first determine whether an environment characteristic sensor 908 is equipped (1014). In other implementations of the logic flow 1002, the tamper evident security system 318/802/902 may presume that it is equipped or not equipped with the environment characteristic sensor 908.

Where the tamper evident security system 318/802/902 is equipped with the environment characteristic sensor 908, the environment characteristic sensor 908 initially detects an environment characteristic (816). The detected environment characteristic may then be converted (1018). Converting the detected environment characteristic may include converting an analog signal representing the detected environment characteristic to a digital signal, and converting the digital signal to one or more numerical values. Other conversion methods are also possible.

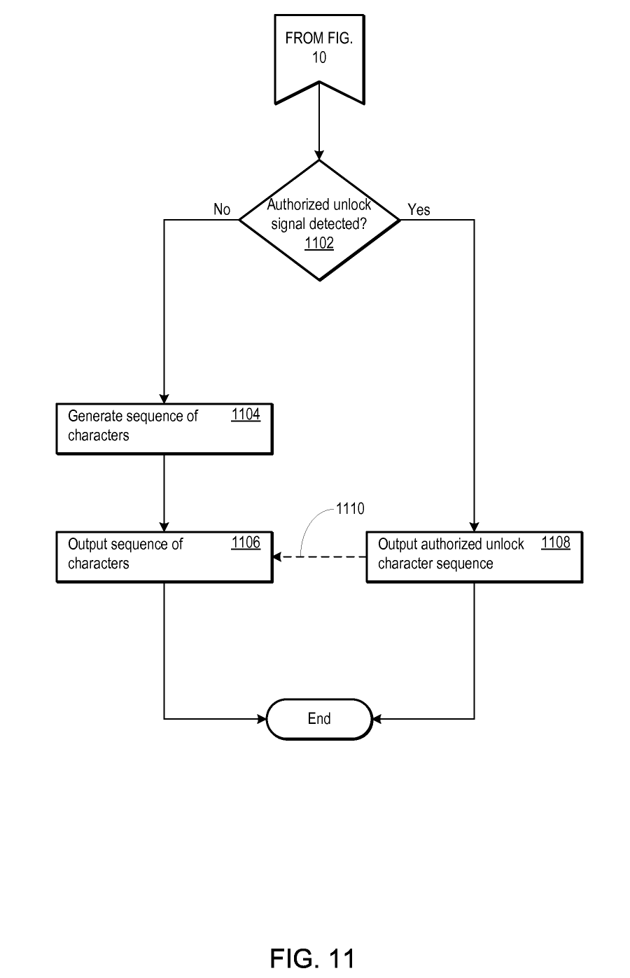

FIG. 11 continues the logic flow from FIG. 10. The tamper evident security module 706 may then determine whether an authorized unlock signal was detected (1102). Where the authorized unlock signal is not detected, the tamper evident security module 706 may generate the sequence of characters based on the environment characteristic detected by the environment characteristic sensor 908 (1104) and by invoking the random character generator logic 904. Alternatively, the tamper evident security module 706 may generate the sequence of characters by invoking the pseudo-random character generator logic 708, by invoking the predetermined character generator logic 804, or combination thereof. The generated sequence of characters is then output to the output device 326 (1106).

Where the authorized unlock signal is detected, the tamper evident security module 706 outputs the authorized unlock character sequence (1108). In addition, the logic flow may follow the logic path 1110 in which the tamper evident security module 706 generates the sequence of characters (1106). Alternatively, the sequence of characters may be generated (1104) after the output of the authorized unlock character sequence (1108). Additional or alternative implementations are also possible.

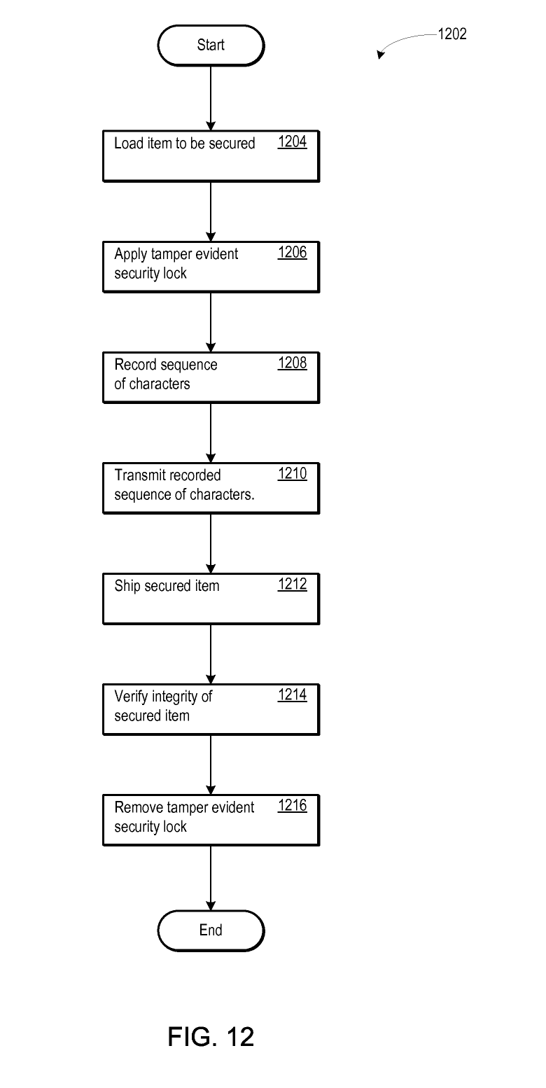

FIG. 12 shows one example of logic flow 1202 in applying the tamper evident security lock 100/200. The logic flow 1202 shown in FIG. 12 is in the context of shipping an item to be protected by the tamper evident security lock 100/200. However, the logic flow 1202 may be applied to any activity, including shipping, receiving, securing, transporting, or any other activity that may use the tamper evident security lock 100/200.

Initially, an item to be secured with the tamper evident security lock 100/200 is loaded with goods (1204). The item to be secured may be a shipping container or other item capable of carrying goods. Alternatively, the item to be secured may be an item that is not loaded with goods. Examples of items to be secured that may not be loaded with goods include automobiles, building materials, and other items. In general, however, the item to be secured may be any item securable with the tamper evident security lock 100/200.

The tamper evident security lock 100/200 is then applied to the item to be secured (1206). Applying the tamper evident security lock 100/200 to the item to be secured may include, and is not limited to, locking the tamper evident security lock 100/200, activating the tamper evident security system 318/802/902, unlocking the tamper evident security lock 100/200, outputting a sequence of characters on the output device 326, or other activity in applying the tamper evident security lock 100/200 to the item to be secured. As one example, the item to be secured may be a shipping container, and the shipping container may have a latch on a door of the shipping container through which the shackle 104 of the tamper evident security lock 100/200 is slidably insertable. In this example, when the shackle 104 is slidably inserted through the latch, and the shackle 104 is moved from the unlocked position to the locked position, the tamper evident security system 318/802/902 may be activated and may display the sequence of characters through the cutout portion 112.

Where applying the tamper evident security lock 100/200 to the item to be secured includes outputting a sequence of characters to the output device 326, the sequence of characters may be recorded (1208). Recording the sequence of characters may include recording the sequence of characters to a computer-readable medium, such as a hard disk drive (HDD), recordable compact disc (CD-R), or other computer-readable medium. Recording the sequence of characters may also include recording the sequence of characters to a non-computer-recordable medium, such as paper or other medium.

The recorded sequence of characters may then be transmitted to the recipient of the item to be secured (1210). Transmitting the recorded sequence of characters may include electronic transmission and non-electronic transmission of the recorded sequence of characters. Examples of electronic transmission include wireless transmission techniques, wired transmission techniques, or a combination of wired and wireless transmission techniques. Examples of non-electronic transmission techniques include sending the recorded sequence of characters via courier, sending the recorded sequence of characters via regular mail, or other non-electronic transmission technique. In some situations, the recipient of the item to be secured may also be the shipper of the item to be secured.

The item secured by the tamper evident security lock 100/200 is then shipped to the recipient (1212). In some instances, the item secured by the tamper evident security lock 100/200 may be shipped to the recipient (912) before the recorded sequence of characters is transmitted to the recipient.

After receipt of the secured item, the recipient may verify the integrity of the secured item (1214). Verifying the integrity of the secured item may include inspecting the sequence of characters output by the output device 326. In one implementation, verifying the sequence of characters output by the output device 326 includes comparing the sequence of characters output by the output device 326 with the transmitted sequence characters transmitted by the shipper. In this implementation, where the sequence of characters are identical, the integrity of the secured item may not have been compromised. Similarly, where the sequence of characters are not identical, the secured item may have been compromised. Alternatively, or in addition, the recipient may use other techniques to verify the integrity of the secured item.

The tamper evident security lock 100/200 is then removed from the secured item (1216). Removing the tamper evident security lock 100/200 may include using an unlock mechanism, such as a key or combination code, to unlock the tamper evident security lock 100/200. Other unlock mechanisms are also possible.

Exemplary aspects, features, and components of the system were described above. However, the system may be implemented in many different ways. For example, although some features are shown stored in computer-readable memories (e.g., as logic implemented as computer-executable instructions or as data structures in memory), all or part of the system and its logic and data structures may be stored on, distributed across, or read from other machine-readable media. The media may include hard disks, floppy disks, CD-ROMs, a signal, such as a signal received from a network, received over multiple packets communicated across the network, or received at an antenna or other receiver.

The system may be implemented with addition, different, or fewer components. As one example, a processor may be implemented as a microprocessor, a microcontroller, a DSP, an application specific integrated circuit (ASIC), discrete logic, or a combination of other types of circuits or logic. As another example, memories may be DRAM, SRAM, Flash or any other type of memory. The processing capability of the system may be distributed among multiple components, such as among multiple processors and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (e.g., a dynamic link library (DLL)). The DLL, for example, may store code that implements functionality for a specific module as noted above. As another example, the DLL may itself provide all or some of the functionality of the system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A tamper evident padlock comprising:
a memory storage device that stores executable instructions that define a tamper evident security module, the tamper evident security module operable to generate a sequence of characters;
a processor in communication with the memory storage device and operable to execute the executable instructions;
an actuator in communication with the processor and movable between a first state that does not activate the processor to a second state that activates the processor to execute the executable instructions;
a movable activation member in communication with the actuator and operable to move the actuator from the first state to the second state; and,
an output device in communication with the processor and operable to output the sequence of characters generated by the tamper evident security module.

2. The tamper evident padlock of claim 1 where the tamper evident security module comprises pseudo-random character generator logic operable to generate the characters pseudo-randomly.

3. The tamper evident padlock of claim 1 where the tamper evident security module comprises predetermined character generator logic operable to generate the characters in a predetermined sequence.

4. The tamper evident padlock of claim 1, further comprising:
a sensor in communication with the processor and operable to detect a environment characteristic of an environment surrounding the sensor; and
where:
the tamper evident security module comprises sensor characteristic conversion logic operable to convert the characteristic detected by the sensor into at least one numerical value; and,
the tamper evident security module is further operable to generate the sequence of characters from the at least one converted numerical value.

5. The tamper evident padlock of claim 1 further comprising an outer housing comprising a cutout portion, wherein the output device is mounted within the cutout portion and the sequence of characters is displayable through the cutout portion.

6. The tamper evident padlock of claim 1 where the movable activation member enters an unlocked position when the movable activation member moves the actuator from the first state to the second state.

7. The tamper evident padlock of claim 1, where the movable activation member enters a locked position when the movable activation members moves the actuator from the first state to the second state.

8. The tamper evident padlock of claim 1 where the sequence of characters comprises an alphanumeric character.

9. The tamper evident padlock of claim 1 where the sequence of characters comprises a character representing a color.

10. The tamper evident padlock of claim 1 further comprising:
an authorization sensor operable communicate an authorized unlock signal when an authorized unlock mechanism is present; and where:
the tamper evident security module comprises authorization logic operable to generate an authorized unlock character sequence in response to the authorized unlock signal; and,
the output device is further operable to output the authorized unlock character sequence.

11. A method for securing an article using a tamper evident padlock comprising:
implementing executable instructions that define a tamper evident security module, where:
the executable instructions are executable by a processor; and,
the tamper evident security module is operable to generate a sequence of characters when the executable instructions are executed;
configuring an actuator to move from a first state that does not activate the processor to execute the executable instructions to a second state that activates the processor to execute the executable instructions;
moving a movable activation member in communication with the actuator to move the actuator from the first state to the second state; when the actuator is moved to the second state that activates the processor, executing the executable instructions to generate the sequence of characters; and
when the sequence of characters are generated, outputting the generated sequence of characters.

12. The method of claim 11, further comprising:
generating the sequence of characters in a pseudo-random sequence.

13. The method of claim 11, further comprising:
generating the characters in a predetermined sequence.

14. The method of claim 11, further comprising:
detecting an environment characteristic of an environment;
converting the detected characteristic into at least one numerical value; and
generating the sequence of characters from the at least one converted numerical value.

15. The method of claim 11 where outputting the generated sequence of characters comprises outputting the generated sequence of characters through a cutout portion of an outer housing of a padlock.

16. The method of claim 11 further where moving the movable activation member comprises moving the movable activation member to an unlocked position.

17. The method of claim 11, further where moving the movable activation member comprises moving the movable activation member to a locked position.

18. The method of claim 11 where the sequence of characters comprises an alphanumeric character.

19. The method of claim 11 where the sequence of characters comprises a character representing a color.

20. The method of claim 11, further comprising:
detecting the presence of an authorized unlock mechanism;
communicating an authorized unlock signal when the authorized unlock mechanism is detected;
generating an authorized unlock character sequence in response to the authorized unlock signal; and,
outputting the authorized unlock character sequence.
